(19) United States
(12) Patent Application Publication
(10) Pub. No.: US 2008/0269922 A1
(43) Pub. Date: Oct. 30, 2008

(54) PERFORMANCE MAPS FOR ACTUATOR INTELLIGENCE

(76) Inventor: Delbert Tesar, Austin, TX (US)

Correspondence Address: HULSEY IP INTELLECTUAL PROPERTY LAWYERS, P.C., 919 Congress Avenue, Suite 919, AUSTIN, TX, 78701, US

(21) Appl. No.: 12/110,992

(22) Filed: Apr. 28, 2008

Related U.S. Application Data
(60) Provisional application No. 60/914,211, filed on Apr. 26, 2007.

(51) Int. Cl. G05B 13/02

(52) U.S. Cl. 700/49

(57) ABSTRACT

A four level fault tolerant architecture for the intelligent machine system is based on the basic component of a self contained actuator module with standardized interfaces. This system architecture organizes all of the operational software to make it universal, high performing, fault tolerant, and use condition-based maintenance. The independent structural layers are structured and prioritized by the advanced electronic controllers. The sensor module creates an accurate parametric representation of the electro-mechanical actuator, and manages all resources in the electro-mechanical actuator. The system will also comprise of operational criteria, maximum performance envelopes, condition-based maintenance, fault tolerance, layered control, and force/motion control. The system allows independent development of different components of the framework, categorized into three levels: the management level, the servo control level, and the senor and communication level. The present disclosure establishes a fully responsive actuator whose intelligence manages a sufficiently broad set of choices.

### RELATED APPLICATIONS

This application claims the benefit of priority to U.S. Provisional Patent Application No. 60/914,211 entitled “PERFORMANCE MAPS FOR ACTUATOR INTELLIGENCE,” by Dr. Delbert Tesar filed on Apr. 28, 2007, and is incorporated herein by reference in its entirety for all purposes.

### FIELD

The disclosed subject matter relates to mechanical systems for the transfer and control of motive forces and control of such systems and processes. More particularly, this disclosure relates to a novel and improved method and system for making, using, and improving performance maps for actuator intelligence as may be apply to a broad array of standardized and other rotary, linear, and other types of actuator devices and systems employing such devices.

### DESCRIPTION OF THE RELATED ART

Dexterous intelligent machines can be reconfigured, repaired, or maintained by rapid replacement of modules, and is one of their successful attributes. However, the basic module of these systems is the actuator, and actuator technology has been stagnant for decades, and the re-configurability at this system level does not exist. Development of an actuator architecture where resource allocation becomes feasible and standardized in the industry, so that components like magnetic circuits, sensors, buses, gearings , brakes, and clutches can be reconfigured, repaired, and maintained better is a necessary step in the evolution of dexterous intelligent machines.

Actuators are still designed as specialty item to for use as a particular solution to a unique problem, with only indirect input from the user. They are made up of individual components, which have not been designed to be integrated into a larger system. Consequently, the systems weigh too much, exhibit too much backlash, too much rotary inertia, and too little stiffness; they also remain expensive with no interface standards to make their utilization in larger systems logical and cost effective. Accordingly, there is a need to develop actuators to perform parallel to the computer chips capabilities.

While computational capabilities have grown drastically in recent decades, the biological equivalence in motor capacity for machine systems is in its infancy. Lack of progress is primarily due to the inattention to the intelligent actuator which serves as the connection between the computer and the physical task. Similar attention to electro-mechanical actuators that was paid to electrical valves (analog tubes) in the 1950's is necessary to achieve the intelligent motor capacity of biological systems.

Unfortunately, electrical prime movers combined in a full and balanced architecture with gear transmissions, brakes, clutches, sensors, electronic controllers, and decision making software have not been given sufficient attention by scientists and engineers to make them sufficiently competitive with alternate technical solutions (hydraulics, pneumatics) except in special applications. The normal rated output (horsepower−fixed load and velocity) is the most demanding requirement that can be specified for this class of system. By contrast, most applications for electro-mechanical actuators (EMA's) require a response to widely varying duty cycles, which may represent an average of only 20% of this rated horsepower. This is especially true of the field of intelligent machines (robotics, manufacturing cells, aircraft control surface operation, ship water vane operation, etc.). We note that peak loads on these electro-mechanical actuators may be as much as ten times higher than the rated loads for short periods (e.g., 1 sec). This strongly suggests that a more inclusive performance measured demands now be developed if all resources in the electro-mechanical actuator can be best used to maximize performance against a known duty cycle.

A major missing piece to electro-mechanical actuators is the lack of best duty cycle information with performance characteristics of the electro-mechanical actuator. Previously, a fixed (rated) representation of electro-mechanical actuators has been accepted because there was virtually no awareness of the actual condition (temperature, magnetic field saturation, magnet deterioration, etc.) of the prime mover and associated components in the electro-mechanical actuator. The missing data is caused by use of a single sensor (measuring output position) to characterize the operation of the actuator. Without sufficient sensors to measure actuator outputs, there has been very little awareness of the true capabilities of the actuator, and the electro-mechanical actuator is typically restrained to operation in the conservative range. Expansion of the range is essential in advancing this technology.

With fully developed architecture established, development of the necessary components to design intelligent actuators needs to be addressed. Because these systems are nonlinear, the deployed actuators are highly coupled, and the actuators themselves are highly nonlinear, it becomes necessary to develop a specific scientific approach to manage the actuator response by means of criteria fusion, ranked, and normalized criteria, with priority setting done primary by human judgment. Therefore an actuator software system needs to be developed for the expansion for the electro-mechanical actuator architecture.

Like other systems that would benefit from intelligent electro-mechanical actuators, commercial aircraft are increasingly complex with more fly-by-wire technology, more communications equipment, and higher safety standards. Uncertainty associated with maintenance, false alarms, and sudden failures are all costly problems with current technology employed in aircraft. Present aircraft control surfaces are complex systems, operated by electro-hydraulic actuators that require a distributed mix of wiring, tubing, connections, valving, hydraulic servo valves, and pistons, and hydraulic reservoirs. As well as being complex, these systems are heavier than an intelligent electrical actuator alternative.

Failure points in the traditional system have led to fault tolerance, which implies redundancy, but also drives up weight and cost. There is also a question of safety associated with flight control actuator subsystem. In the past the actuator system has only be monitored by one sensor, generally a pressure sensor. The data is not sufficient to describe the actuator completely, and results in failures going undetected by operators and maintenance crews.

Mechanical devices are highly non-linear and their operational parameters drift over time due to aging, and extended operation. Increasingly, these devices are becoming more complex, and the user community wants continued improved performance at lower cost. This demand requires the operation of mechanical devices closer to the operational margins of that device, and that classical methods of control based on simplistic linearized models can no longer be the basis for continued growth in the technology. Computational capacity exists that can replace the antiquated analog approach with a digital approach based on quantitative parametric description of the mechanical system and its real time “sensor” reference derived from a full array of internal sensors. However, there needs to be developed a decision paradigm based on criteria such as performance maps, performance envelopes, and trends of device capacity.

### SUMMARY

As discussed above, electro-mechanical actuators have been underdeveloped for decades, and are still built as specialty items. The components of these actuators are unique to each system, and are incapable of reconfiguration, repair, and maintenance. As well, the systems are lacking in their ability to operate at efficient rates due to a lack of developed performance characteristics. The intelligent actuator described herein provides the performance and a scope of actuators can be drastically increased through the development of intelligent operating systems and expanded sensor use in the actuator architecture.

According to one aspect of the present disclosure, a four level fault tolerant architecture for the intelligent machine system based on the basic component of a self contained actuator module with standardized interfaces. This system architecture then organizes all of the operational software development to not only make it universal for all configurations under this architecture but to also make high performance, fault tolerance and condition-based maintenance possible. In the present disclosure, the system level and module levels are split into four independent structural layers which will be structured and prioritized by the advanced electronic controllers. The sensor module will be used to create an accurate parametric representation of the “as-built” electro-mechanical actuator through extensive testing, and mange all resources in the electro-mechanical actuator, known as a “performance maps,” to best match the needs of any given duty cycle. With a fully established actuator architecture, a well defined set of operational criteria (performance map), and an emerging decision making process (operational software), the present disclosure will also comprise of maximum performance envelopes, condition-based maintenance, fault tolerance, layered control, and force/motion control.

The architecture system allows independent development of different components of the framework. The components are categorized into three levels: the management level, the servo control level, and the senor and communication level. The present disclosure establishes a fully responsive actuator whose intelligence manages a sufficiently broad set of choices (performance, duality, layered control, force/motion, etc.).

These and other advantages of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, feature, and advantages here provided will become apparent to one with skill in the art upon examination of the following FIGUREs and detailed description. It is intended that all such additional systems, methods, features, and advantages be included within this description, be within the scope of the accompanying claims.

### BRIEF DESCRIPTION OF THE DRAWINGS

The features, nature, and advantages of the disclosed subject matter will become more apparent from the detailed description set forth below when taken in conjunction with the drawings in which like reference characters identify correspondingly throughout and wherein:

FIG. 1 is a block diagram of an intelligent machine system according to the present disclosure;

FIG. 2 shows a generalization of a real system on which the techniques described in this section were applied;

FIG. 3 is a flow chart of the method of the internal decision making process according to the present disclosure;

FIG. 4 is a cross-section diagram of a mechanical actuator; and

FIG. 5 is a diagram of the operational software.

### DETAILED DESCRIPTION OF THE DISCLOSURE

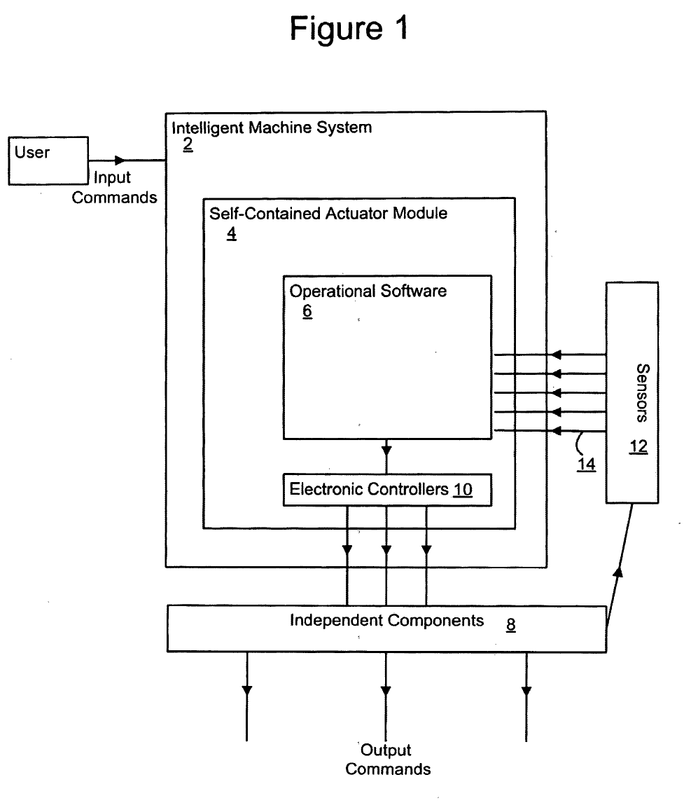

The present disclosure, represented in FIG. 1, is a four level fault tolerant architecture for the intelligent machine system 2 based on the basic component of a self-contained actuator module 4 with standardized interfaces. This system architecture then organizes all of the operational software 6 development to not only make it universal for all configuration under this architecture but to also make high performance, fault tolerance, and condition-based maintenance possible. Similar generality is also present in the actuator itself. At the system level, there are four independent structural layers, and the same will occur within the actuator. Multiple independent components 8 (magnetic circuits, poles, magnets, etc.) will be structured and prioritized by advanced electronic controllers 10 (in hundredths of a millisecond) which are in themselves redundant and reconfigurable. Multiple sensors 12 monitor these components, and send Feedback 14 into the operational software 6. The development is a responsive decision making structure to provide for the best resource allocation in that architecture to not only assure that high performance occurs (while reducing costs) but that this method of control makes possible fault avoidance (even during operation) and condition-based maintenance to allow for the timely replacement of actuators which function below an acceptable performance index.

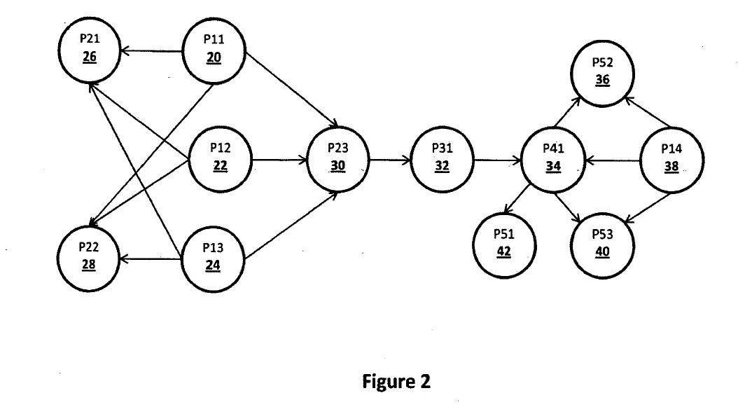

In order to be able to generate decision surfaces in real time one needs to have a well-defined model of the system. It is quite possible to build system models purely from first principle but such models often neglect nonlinearity and operational uncertainty. The present disclosure takes a causal network approach to modeling the system with 12 parameters (that can be considered to be of interest during the operation of these systems). FIG. 2 shows a generalization of a real system on which the techniques described in this section were applied. This simple model is used to illustrate the methodology to obtain decision surfaces and decision criteria in real time. The same methodology can then be applied to any MIMO system that is modeled on similar lines.

Parameters are connected to each other with arrows that signify causality. P11 20, P12 22, and P13 24 affect the parameters P21 26, P22 28, and P23 30 and therefore there are arrows pointing from P11 20, P12 22, and P13 24 towards P21 26, P22 28, and P23 30. Similarly P23 30 causes P32 32 and hence the arrow from P23 30 to P32 32. The full system model is represented this way.

Once an initial causal network is put in place, it needs to be converted into a Bayesian causal network. This involves three steps; resolving conditional independence and direct indirect relationships; resolving the direction of arrows; and eliminating circular relations. These steps need to be followed to obtain a model that is robust for the sum of the mathematical manipulation required later. Creation of such a system model requires the interaction of both the system designer and system user to ensure that the relevant parameters are used and also to be certain that causality among the parameters have been properly assigned.

The model at this stage is purely qualitative. Data needs to be collected to properly represent both the nonlinearities and the uncertainties in the relationship between the linked parameters. The relationships among the parameters are obtained by conducting experiments (through parametrically structured tests) and/or analytical modeling. Uncertainties in data collected can be represented probabilistically and stored in either a continuous or discrete form.

Full conditional probability tables (CPTs) for all parameter relationships need to be obtained by experimentation, where the experiment is repeated for different values of each parameter. Now that the full model has been defined, decisions surfaces can be generated as demanded by a decision scenario.

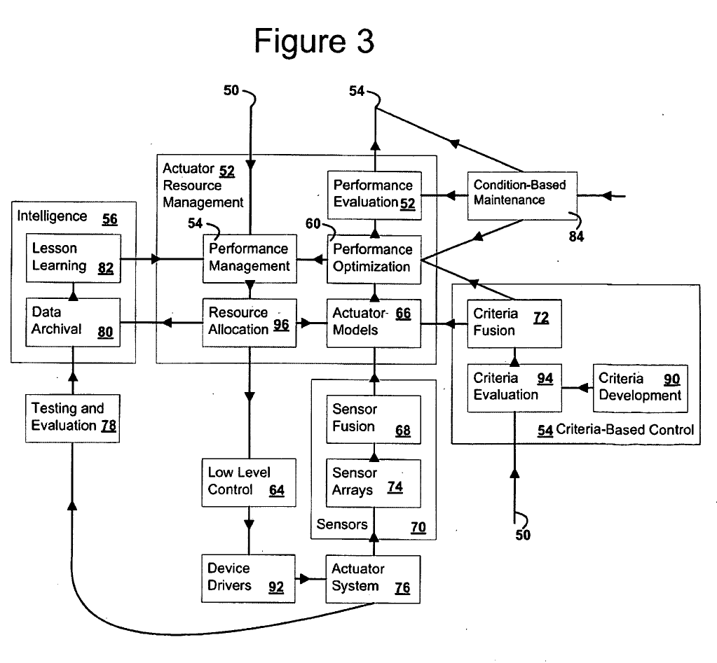

The internal decision making process is outlined in FIG. 3. Inputs 50 enter the actuator resource Manager 52 and the criteria-based Control 54 where evaluation begins. In the actuator resource manager 52, inputs 50 are first addressed by the performance management 56 component, which uses information from the intelligence 58 module, and from the performance optimization 60 component. Performance management 56 relays its output to the resource allocation 62, where the commands for the low level control 64 are initiated. The information from resource allocation 62 is also sent to the actuator model 66 for evaluation. The actuator models 66 receives information from resource allocation 62, sensor fusion 68 from the sensors 70, and from criteria fusion 72 from the criteria-based Control 54. Sensor arrays 74 process data from the actuator System 76 in the sensors 70. The data is also sent to the Testing and Evaluation 78 component to be used in the intelligence 58 module for Data Archival 80 and Lesson Learning 82. Performance optimization 60 is evaluated from the actuator models 66, criteria fusion 72, and Condition-based maintenance 84, where it is used again in the performance management 56. A performance evaluation 86 is conducted from the performance optimization 60, and Condition-based maintenance 80, and relayed as Outputs 88. Outputs 88 may be used by the user for criteria Development 90 in the criteria-based Control 54.

The architecture will combine the best duty cycle information with performance characteristics of intelligent electro-mechanical actuators to obtain an expanded performance envelope. In the past, we have accepted fixed (rated) representations of electro-mechanical actuators because we had virtually no awareness of the actual condition (temperature, magnetic field saturation, magnet deterioration, etc.) of the prime mover and associated component in the electro-mechanical actuator. This was because normally only one sensor (to measure output position) was used to characterize the operation the actuator. Here, multiple sensors will be used to create an accurate parametric representation of the “as-built” electro-mechanical actuator through extensive testing, and manage all resources in the electro-mechanical actuator (through performance maps) to best match the needs of any given duty cycle.

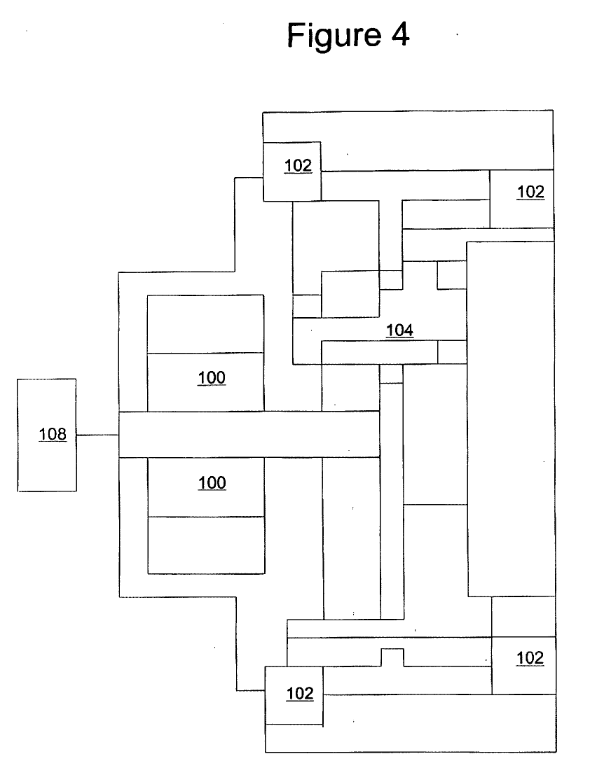

The architecture system establishes a fully responsive actuator whose intelligence manages a sufficiently broad set of choices (performance, duality, layered control, force/motion, etc.) using carefully documented criteria of the components represented in FIG. 4, like the prime mover 100, bearings 102, gear trains 104, power supply 106, and electronic controller 108; when combined by fusion mathematics, the criteria enables deployment to the widest range of systems (aircraft, ships, space, surgery, etc.). This intelligence is built on the nature of electro-magnetic prime movers, rolling element bearings, tooth mesh reducers, and electronic power supplies. Included in the intelligent actuator system is the fully established actuator architecture, a well defined set of operational criteria, and a decision making process allowing the maximum performance envelope, condition-based maintenance, fault tolerance, layered control, and force/motion control to be employed by the system.

An actuator is a multiple input, multiple output (MIMO) system. The performance parameters torque, noise, loss, actuator temperature, speed, etc., ban be managed by varying control parameters such as voltage, current, turn on angle, and turn off angle. Parameters such as load and external temperature are disturbance parameters but can also be considered as control parameters. The first step to using the visual framework described in this paper is to envision all the different possible actuator operational scenarios that could occur during the life of the actuator.

Examples of such scenarios being the following:
Run the actuator quieter than it's normal operational quietness;
Operate the actuator at torque of say more than 0% peak load and an efficiency of at least 60%.

Scenarios such as these help us list all the parameters (performance parameters and control parameters) that are of importance. A causal network is then built encompassing all these parameters and the relationships among the parameters (including the uncertainty in the relationships) are arrived at either through experiments or analytically.

Now one may use the framework described herein to provide visual data to the HDM to aid the operator to make decisions. For example, the visual plots that may be shown in relation to the scenarios described previously are possibly as follows:

A noise envelope with respect to turn on angle and turn off angle. The envelope is created varying the other control parameters; voltage and current fro the load acting on the actuator at the instant under consideration.). The decision surface is normalized and current operation point is shown on the surface. The Human Decision Maker (HDM) makes a choice of a quieter operation point by looking at the surface.

A surface showing regions in the operational regime where both the torque is greater than 70% peak and the efficiency is greater than 60%. We use the area normal to arrive at this surface.

Modern systems, such as commercial aircraft, are increasingly complex, and use advanced techniques like fly-by-wire technology, more communications equipment, and use higher safety standards. It is highly desirable to have their operation and maintenance provided by a well trained technician. Condition-based maintenance is the on-going assessment of the condition (level of performance) of critical components in the system (actuators, sensors, communication buses, radar systems, etc) to determine whether the system's overall performance meets acceptable criteria. If this performance level is marginal or unacceptable, the operator is so advised and given suggestions on what actions should be taken to remedy the problem. Increasing the personnel's knowledge of the systems performance levels enables them to operate the system better, know how and when to maintain it, how to recommend improvements in maintenance, and how to recommend improvements in design. Condition-based maintenance would reduce false alarms, sudden failures, and ownership costs.

Another modern system benefiting from the present disclosure is an unmanned ground vehicle (UGV). The UGV is made up of multiple actuators, and they many not all have the same performance capabilities. Causal models need to be built for each of the actuators. Each actuator causal model becomes a subset of the UGV causal model. Here also, one needs to conduct a UGV operational scenario analysis to begin with, to identify the various parameters of interest on the UGV level.

Future automobiles will be designed to expand human choice. These might include maximizing acceleration, improving gas mileage, or enhancing the overall safety of the vehicle. This will lead to multi-speed electric drive wheels, active suspensions, intelligent brakes, reconfigurable tires, etc. All this eliminates passive systems all with minimal choices for the human operator. Gear shifts are now either human controlled or by means of computers; brakes are now also more intelligent.

Fault tolerant systems are another area that may have a large impact on modern systems. Contemporary aircraft are an example system, where present control surfaces are operated by electro-hydraulic actuators that require a distributed mix of wiring, tubing, connections, valving, hydraulic servo valves and pistons, and hydraulic reservoirs. An intelligent electrical actuator creates a more electric aircraft that would provide a homogeneous technology, which is not only simpler (smaller number of parts), it is fault tolerant with no single point failures (ensuring operation even under a major fault), it reduces the overall actuation subsystem weight by more than fifty percent, and it significantly reduces total ownership costs. The new actuator module would concentrate on the general architecture of dual force path rotary and linear electrical actuators based on a series of the most advanced component technologies (sensors, clutches, brakes, etc.). The actuator would include sensors to generate real time data to quantify the actual condition of the actuator, which when compared to its model reference through a set of ranked criteria may approach its maximum performance envelope at low risk. This system not only maximizes performance, it makes condition-based maintenance and fault tolerance possible.

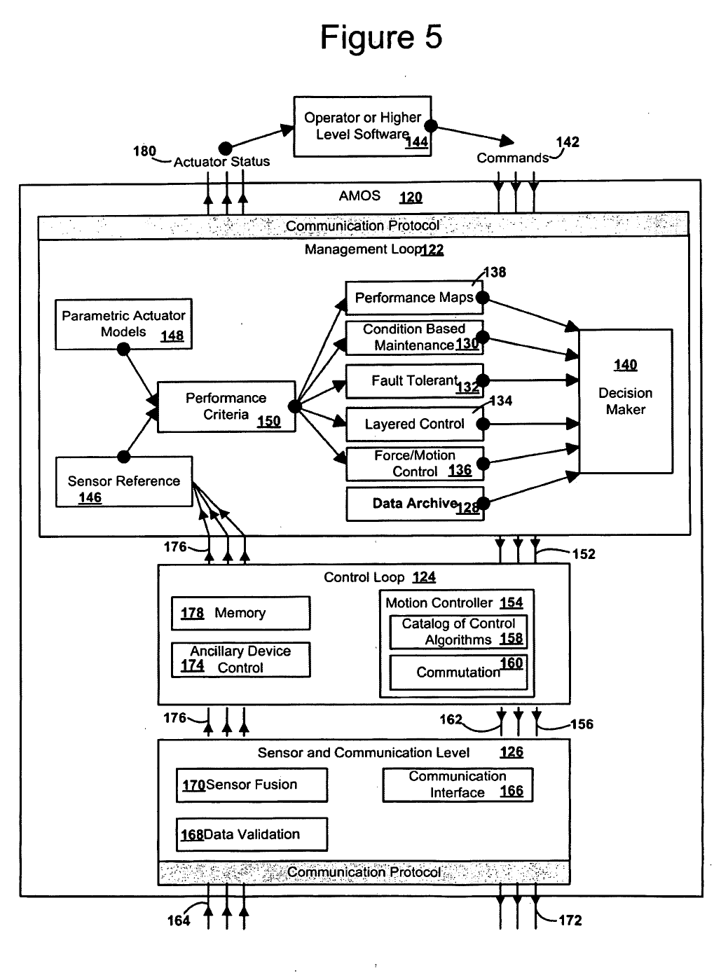

Actuator embedded software is essential to provide functionality like motor commutation, communication, data processing, and implementation of various features that collectively contribute to actuator intelligence, namely, criteria-based decision-making algorithms, Condition-Based maintenance routines etc. Information from sensors has to be analyzed, interpreted and manipulated systematically in software to produce information of value to the higher levels of the control hierarchy. A layered architectural style (represented in FIG. 5) suits the top-level design of “Actuator management Operational Software” (AMOS) 120. This allows independent development of different components of the framework. The components are categorized into three level requirements: the management level 122, the servo control level 124, and the sensor and communications level 126 with the loop update frequency rates increasing from the management to the communication level. Considering code extensibility, encapsulation, inheritance, and reusability, an object-oriented style is suitable for the detailed low-level design for the subsystems of AMOS. This includes classes in Data Archive 128 that support error-handling, mathematical functions, storage of actuator-related data, abstraction of input-output devices, inter-process and network communications, algorithms for sensor data validation and fusion, Condition-Based maintenance 130, Fault Tolerance 132, Layered Control 134, Force/Motion control 136, Data Archive 128 information (performance envelope generation, criteria fusion etc.) and performance Maps 138 which are used in decision making processes 140. At the management level 122 AMOS receives input commands 142 from higher level software or the user 144. These commands are then processed; along with a combination of the stored actuator performance maps and envelopes from Data Archive 128, the measured sensor reference 146, parametric actuator models 148 and performance criteria 150 to yield appropriate control signals 152 for actuator operations. In addition to state variables, high level information like actuator condition or available performance envelope, etc is passed back to the host software (rather than raw data). At the control level 124, the motion controller 154 translated the control signals into the “real” commands 156 (by modulating control parameters like current, voltage, etc.) for actuator control. Motion controller 154 consists of a catalog of control algorithms 158, each designed to provide the best control under the given conditions for its component, and Commutation 160 methods. The control level 124 is also responsible for the control of ancillary device signals 162 for brakes, lubricant/cooling systems etc. The communication level 126 includes communication between AMOS modules, the communication between the actuator and the controller, etc. The sensor and communication level 126 is responsible for sensor feedback 164 (data acquisition), filtering at the communication interface 166, data validation 168, and data fusion 170 of information obtained from all the sensors.

Performance demands (torque/power density, efficiency, responsiveness, etc.) on actuators as the drivers of multi-purpose machines continue to increase requiring that all resources in a full architecture of intelligent electro-mechanical actuators (EMAs) be utilized. To do so, means to fully embed nonlinear performance models of all the actuator components (power supply/controller, prime mover, bearings, gear meshes, etc.), combine the associated performance maps into performance envelopes and to confirm those using sensors to generate real-time operational data to support human-directed decision making to satisfy system level performance demands.

Nonlinear behavior results from parametric coupling among power parameters (torque/speed, voltage/current), operating parameters (e.g. bandwidth), and the operating environment (e.g. temperature). An actuator's ability to respond intelligently to unstructured environments that demand varying degrees of performance is restricted by its capability to accurately sense and interpret its operating conditions. With a minimal set of sensors there is little awareness of actual operating conditions. An extensive sensor suite can help to comprehensively map the actuator operational characteristics in real-time and monitor the variation of actual parameters relative to the “as-built” parameters. For condition-based maintenance, all the key actuator parameters can be continuously monitored for any signs of degradation by dynamically mapping sensor data to a fault-sensitive model of knowledge of it operating characteristics at all times and can re-configure itself to adapt to different operating conditions. This enables implementation of feature like fault tolerance, criteria-based control, etc. through a combination of the real-time sensor-inferred and theoretical analytical models in a unified decision making structure with effective performance criteria, maps and envelopes to achieve user-specified goals.

In summary, the present disclosure provides an intelligent machine system operating inside a conditional envelope capable of quick and accurate decisions when multiple objectives are involved. The disclosure includes a multiple input/multiple output self-contained actuator module for quickly and accurately completing complex tasks. A plurality of advanced electronic controllers contained within the multiple input/multiple output self-contained actuator module provide quick and accurate movements for performing the quickly and accurately completing the complex tasks. A plurality of sensors measure internal and external conditions of the advanced electronic controllers for providing access to environmental conditions of the multiple objectives. Operational software operates on the multiple input/multiple output self-contained actuator module from conditions provided by the user, previously programmed instructions, and feedback from the plurality of sensors measured conditions of the advanced electronic controllers for making quick and accurate decisions for quickly and accurately completing the complex tasks.

According to one aspect of the disclosure, an intelligent machine system includes multiple input/multiple output self-contained actuator module that may have standardized interfaces, as well as a plurality of independent structural layers. A plurality of independent structural layers may be structured and prioritized by the advanced electronic controllers. The performance map features and functions described herein can be implemented in various manners. For example, not only may the performance maps operate in conjunction with the various actuator devices discussed, but also the present embodiments may be implemented in a microcontroller, a microprocessor, or other electronic circuits designed to perform the functions described herein. The foregoing description of the preferred embodiments, therefore, is provided to enable any person skilled in the art to make or use the claimed subject matter. Various modifications to these embodiments will be readily apparent to those skilled in the art, and the generic principles defined herein may be applied to other embodiments without the use of the innovative faculty. Thus, the claimed subject matter is not intended to be limited to the embodiments shown herein but is to be accorded the widest scope consistent with the principles and novel features disclosed herein.

I claim:

1. An intelligent machine system operating inside a conditional envelope capable of quick and accurate decisions when multiple objectives are involved comprising:
a multiple input/multiple output self-contained actuator module for quickly and accurately completing complex tasks;
a plurality of advanced electronic controllers contained within said multiple input/multiple output self-contained actuator module for quick and accurate movements for performing said quickly and accurately completing said complex tasks;
a plurality of sensors measuring internal and external conditions of said advanced electronic controllers for providing access to environmental conditions of said multiple objectives;
operational software operating on said multiple input/multiple output self-contained actuator module from conditions provided by the user, previously programmed instructions, and feedback from said plurality of sensors measured conditions of said advanced electronic controllers for making quick and accurate decisions for quickly and accurately completing said complex tasks.

2. An intelligent machine system of claim 1, wherein said multiple input/multiple output self-contained actuator module may have standardized interfaces.

3. An intelligent machine system of claim 1, wherein said multiple input/multiple output self-contained actuator module may have a plurality of independent structural layers.

4. A self-contained actuator module of claim 3, wherein said plurality of independent structural layers may be structured and prioritized by said advanced electronic controllers.

5. An intelligent machine system of claim 1, wherein said plurality of advanced electronic controller may be redundant and reconfigurable.

6. An intelligent machine system of claim 1, wherein said plurality of sensors may monitor position, velocity, acceleration, torque, current, voltage, magnetic field, temperature, sound, and vibration, and other conditions on critical components of said machine system.

7. An intelligent machine system of claim 1, wherein said operational software may contain a means of input, and said input may come from an operator and/or said sensors.

8. An intelligent machine system of claim 1, wherein said operational software may be written on a computer readable media.

9. An intelligent machine system of claim 1, where in said operational software may contain a means of output.

10. A system architecture for monitoring and controlling an intelligent machine system operating inside a conditional envelope capable of quick and accurate decisions when multiple objectives are involved comprising:
an intelligence module for storing and learning from said criteria-based control and internal and external conditions of said advanced electronic controllers for adding to said conditional envelope;
a sensor module measuring internal and external conditions of said advanced electronic controllers for providing access to environmental conditions of said multiple objectives;
a criteria-based control for containing and adjusting specific capabilities of said advanced electronic controllers derived from said environment conditions of said multiple objectives as indicated by said plurality of sensors;
an actuator resource manager for making quick and accurate decisions for quickly and accurately completing said complex tasks from information from said conditions provided by user, said conditional envelope, said environmental conditions, and said criteria-based control of said multiple objectives.

11. A system architecture for monitoring and controlling an intelligent actuator system of claim 10, wherein said actuator resource manager may be comprised of performance maps, and said performance maps may be developed analytically or from extensive testing of standardized actuator designs.

12. A system architecture for monitoring and controlling an intelligent actuator system of claim 10, wherein said actuator resource manager may be comprised of parametric actuator models.

13. A system architecture for monitoring and controlling an intelligent actuator system of claim 10, wherein said actuator resource manager may support error-handling, mathematical functions, storage of actuator-related data, abstraction of input-output devices, inter-process and network communications, algorithms for sensor data validation and fusion, condition-based maintenance, fault tolerance, performance envelope generation, and criteria fusion.

14. A system architecture for monitoring and controlling an intelligent actuator system of claim 10, wherein said actuator resource manager may comprise a resource allocation, and said resource allocation may control said self-contained actuator module with low-level controls.

15. A system architecture for monitoring and controlling an intelligent actuator system of claim 10, wherein said intelligence module may comprise a data archival, and said data archival may record said self-contained actuator output information.

16. A system architecture for monitoring and controlling an intelligent actuator system of claim 10, wherein said intelligence module may be capable of lesson learning.

17. A system architecture for monitoring and controlling an intelligent actuator system of claim 10, wherein said sensor module relate operating conditions to said actuator resource manager.

18. A system architecture for monitoring and controlling an intelligent actuator system of claim 10, wherein said criteria-based control may evaluate criteria for said actuator resource manager.

19. A method of an intelligent system architecture for an intelligent actuator system operating inside a conditional envelope capable of quick and accurate decisions when multiple objectives are involved comprising the steps:
user-specified criteria is input into said operational software operating on said multiple input/multiple output self-contained actuator module for quickly and accurately completing said complex tasks,
said plurality of sensors measure internal and external conditions of said advanced electronic controllers for providing access to environmental conditions of said multiple objectives;
specified criteria is processed for designating said conditional envelope for operating said multiple input/multiple output self-contained actuator in said environment conditions of said multiple objectives;
quick and accurate movements are generated from said conditional envelope for quick and accurate movements for performing said complex tasks in said environment conditions of said multiple objectives;
said plurality of advance electronic controllers execute said quick and accurate movements performing said complex tasks in said environment conditions of said multiple objectives;

20. A method of an intelligent system architecture of claim 19, wherein said specified criteria are yielded from resources of said actuator resource manager, said criteria-based control, said sensor module, and said intelligence module.
